(19) United States
(12) Patent Application Publication
(10) Pub. No.: US 2004/0090040 A1
(43) Pub. Date: May 13, 2004

(54) Bicycle gadgets

(76) Inventor: David Andrew Pearson, Huntington Beach, CA (US)

Correspondence Address: DAVID PEARSON, 22102 CAPE MAY LANE, HUNTINGTON BEACH, CA, 92646, US

(21) Appl. No.: 10/291,257

(22) Filed: Nov. 12, 2002

(51) Int. Cl. B62J 1/00; B62J 6/00

(52) U.S. Cl. 280/288.4

(57) ABSTRACT

Gadgets and the like for bicycles. Related concepts arise from the describing of the concept. A list of all the (predicted) concepts presented here-in is present in the summary.

### FIELD

Technical

This invention relates to bicycle accessories.

### PRIOR ART

Currently, bicycle lights don't have built-in pop-out mirrors. One of the reasons would be that the rider would be in the way of the rear-view without a telescoping mirror.

### BRIEF SUMMARY

A modification to a light (for bicycles and the like) comprising a retractable telescoping apparatus with a (rear-view) mirror attached. It is expected that such a concept can be used for the retractable devices of handlebar devices Ser. No. 09/451,020, a rear-view mirror, and a head light. it is expected that the concept can also be added to the removable container of handlebar devices and used for another such device; a retractable lock. A bicycle light with a flip out rear-view mirror is predicted. The light is designed to use a phone battery as a power source. It is expected that the telescoping mechanism can double as a telescoping antenna for (such) bicycle lights with built-in radios.

Additional predicted devices for the concept of handlebar devices include a lipstick holder/device, a suntan lotion holder, a lighter holder/device, a match holder, a breath (spray) bottle holder, a perfume (spray) bottle holder, a mister, a survival knife holder/device, a telescope, a tire repair kit, a pump and a locking device that disables the bicycle, an alarm, a firework handlebar grip and a lubrication dispenser. It is predicted that the concepts of handlebar devices and the telescoping method described here-in can be applied to devices of the prior art. Glow-in-the-dark (handlebar) grips and handlebar caps, (glow-in-the-dark) brake grips, (glow-in-the-dark) pedal covers are also predicted.

Modifications to (bicycle) seats including built-in tail lights and built-in packs are also included. Also included are a lighted (reversible) front reflector/headlight and predicted holders for wireless phones and pda's. Also included is a battery (for bicycles with electric motors) that looks like a sports bottle and a sticker designed for bicycles.

Other predicted predicted concepts include a bottle that can be squeezed to eject mist, a squirt gun for bicycles, a water bottle with a rock in it, a double bladed ice adaptor for bicycles, a cover (in the form of a bag) for bicycles, a waterproof outfit designed for bicycle riding, a [(light emitting) diode] clock for bicycles. Other digital devices for bicycles including a thermometer, an altimeter, a barometer, a humidity meter, a GPS, and a fitness computer are also predicted. Also predicted is a plug-in speaker, an adjustable handlebar mount, an apparatus for pets, a wind turbine for electric bicycles, a mister potato head designed as a decoration for the handlebar, a potato with glasses (for the handlebar), generic as a brand name for bicycles, a bicycle basket with a bottle holder, a wind-up motor for bicycles, a bicyclist report, a bicycle calender and a bicycle buyers guide.

Related concepts include a system to rapidly provide electric cars with charged batteries, an apparatus to jump start a car that uses D batteries, a toilet paper holder for which a toilet paper rod is inserted or removed from the outside, a per call billing methed for wireless phones, and a kit for cordless phones to disable the batteries. Other related concepts include a toothbrush grip, a double axled skateboard truck, a skateboard with more than two trucks, a deck cover for skateboards, a shower mat that massages, a telescoping lighter, face bags, a sticker that changes the color of displays, a bubble lamp, a glow-in-the-dark lava light, a lava light that changes colors, an apparatus that brightens glow-in-the-dark embodiments, a razor with built-in light, a windshield wiper for motorcycles and helmets, a combination lock for motor ignition systems, a glow-in-the-dark compass, glow-in-the-dark switches for lamps and the like, an antenna switch for the base unit of cordless phones, the use of multiple antennas, antenna repeaters, antenna extensions, a UHF antenna loop decoration, an antenna ball and a computerized device that processes air wave broadcasts (to strengthen signals).

More related concepts include a mist ejector for cars, a portable large scale mist ejecter, a car battery light, a spark plug switch, a bean bag drink holder, binoculars with built-in lazer, binoculars with built-in flashlight holder, binoculars with removable field illuminators, a barbeque with built-in light, a barbeque with pull-out barbeque ignitor, a barbeque with built-in squirt gun holder, a barbeque with built-in automated douser, a barbeque with built-in drink holder, a barbeque with built-in lighter holder, a barbeque with built-in charcoal lighter fluid dispencer, a barbeque with built-in charcoal lighter fluid container holder, a firework candle, a firework (fireplace log), a roman candle grip, insulated duffel bags and backpacks, a powered fan with the word sports on it, special effects for powered fans, a food dehydrator that uses light (instead of heaters), a device that stores and plays movies, scents for perfume, decorations for key rings, prism effect lamps and candle containers and the number two blow dryer holder.

More related concepts include two concepts for SETI, a razer with a lubricater that's in front of the blade, modifications to recliner chairs and a scale designed for dieters, a wedge shaped storage container for pick-up trucks, a shower mirror an aerodynamic leash plug for bodyboards, the bar report, holders for ball needles and the like that are designed to be installed onto pumps, scenic calenders and post cards with dated pictures (including wild animals), calenders and postcards containing (dated) pictures of natural phenomina, a jive translater, a shakespearian translater, a sign for bars (including one or more humerous pictures) (that says “don't squeeze the bar( )man”), a chain saw designed as a meat carver, and a book for learning foriegn languages.

More related concepts include a fireplace kit that is easy to install, an internal light for a clear phone, a chair for video games, a chair with built-in projector, a shirt with a fake chip on it, an area code button, a surge protector that uses the ground plug component to connect components, a website for opinions about movies, an ice chest with a built-in light, telescoping binoculars and two or more color wheels for fiber optic lights, a collapsable soda bottle, a projector clock that projects the time at predetermined intervals, scoby snacks, a rotissorie basket, a fry basket that doubles as a steam basket, a holder that stores bottles upside down, a shower water control handle with a protrusion on it, a bumper sticker with an embodiment of a green dolfin, a wind-up motor for skateboards, a wind-up motor for cars, a lazer pointer/gun, an attempt at stopping hurricanes, a razor blade handle grip, a razor blade handle a grip for hand held shower nozzles, a prizm on the lense of a flashlight, a lightbulb cover containing one one more prisms and a handheld vacume that uses a easily replacable rechargable battery that is available at retail stores. It is expected that other devices can be designed to use the vacume battery. It is also expected that all lights listed here-in can be designed to use solar panels.

### BRIEF DESCRIPTION OF THE DRAWINGS

FIGS. 1, 2, 7, and 8 are back internal views. FIGS. 3, 12, 17 and 18 are a side views. FIG. 4 is a top view with a partial internal view of the telescoping mirror modification and an internal view of the phone battery modification. FIG. 5 is an enlarged cut-away view. FIGS. 6, 11 and 19 are top views.

FIGS. 9 and 10 are front internal views. FIGS. 13 and 14 are back views. FIGS. 15 and 16 are front views. FIG. 19 is a top view.

### DETAILED DESCRIPTIONS

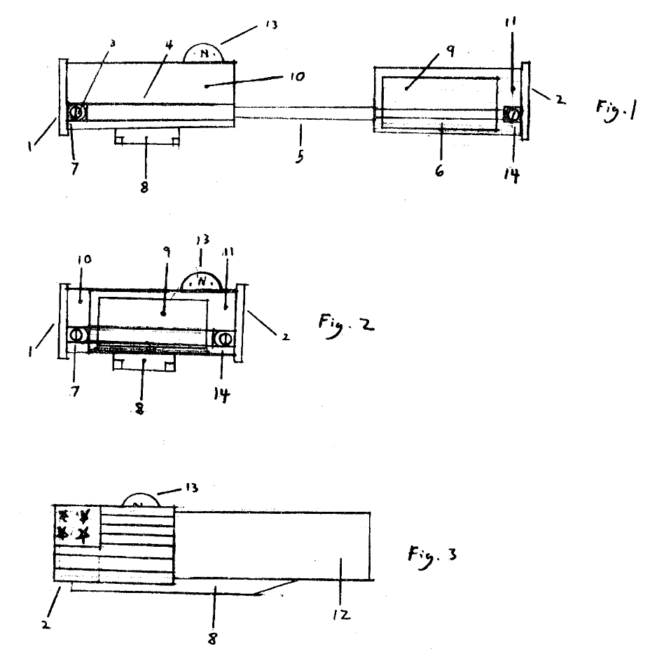

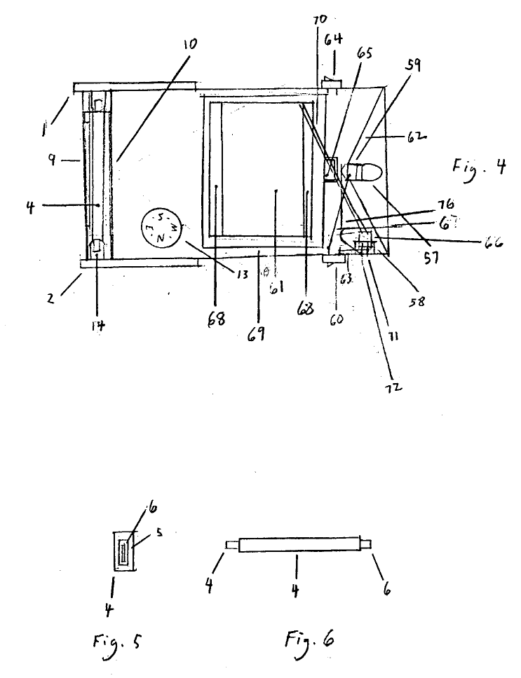

FIGS. 1-4 illustrate an example of the proposed modifications to a bicycle light (the pop-out rear view mirror: 1-7, 9-11 and 14 and the built-in compass 13). In FIG. 1 the pop-out rear-view mirror is deployed (pulled or popped out into position). The embodiment is a bicycle light that has a retractable apparatus containing a rear-view mirror sticking out of it. In FIGS. 2-4 the apparatus is retracted (pushed back into the compartment to regain a symetrical look for the light). Predicted is such a light containing one or more doors that can be opened into position to deploy rear-view mirrors. It is expected that such doors can be closed with a snap-in mechanism when closed. It is expected that the lights can contain two such doors to retain a symetrical look.

The light in this case is designed with one pop-out mirror. In this design, it can be pulled out to the right the light is faced from the rear. Apparatuses with two or more pop-out mirrors that can be deployed from one or more different directions are predicted. (Bicycle) lights with flip out mirrors are predicted.

Related to the light is a predicted concept, binoculars and the like with one or more built-in (detachable) (adjustable beam) flashlights or (adjustabe) (disperce) beam lazers (for viewing in dark conditions). It is expected that the lights can be aimed at the field of view of the binoculars. Also related to the light is another predicted concept; a barbeque with a built-in light. It is expected that (gas) barbeques can be designed with (battery operated) lights. It is expected that the barbeque lights can designed with flexible armatures that retain positioning after repositioning. Also related to the light is another predicted concept; barbeque utensils with built-in lights.

Related to the light is another predicted concept; a lava light with glow-in-the-dark lava. It is expected that such a light can contain an (adjustable) built-in timer that turns the light on and off (to retain a bright glow for the lava).

Also related to the light is another predicted concept; a second color wheel for fiber optic lights: It is expected that one or more color wheels can be added to such devices to increase the dynamics of the color effects. Predicted is a fiber optic light with color wheels that spin in opposite directions.

Also related to the light is another predicted concept; a (glow-in-the-dark) lava light that changes colors: It is expected that the lava light can be designed with one or more color wheels like that of a fiber optic light. It is expected that white lava can be used in such a light. The lava would reflect the color of the light that passes through the wheel.

Also related to the light is another predicted concept; a spotlight with timer for the intention of illuminating glow-in-the-dark embodiments. It is expected that such a light would be designed to be pointed at an object and would be controlled by a timer that turns it on just long enough to energize a glow-in-the-dark embodiment. It is expected that the timer would be programed to turn the light on and off at intervals short enough to keep the embodiment glowing brightly.

Also related to the light is another predicted concept; a bubble light (that changes colors). It is expected that it can be designed with an air pump and (multiple) color wheels such as that of a fiber optic lamp. It is also expected that it can use bubble stones such as that of an aquarium. It is also expected that the color(s), viscosity(s) (and mixabilities) of the (glow-in-the-dark) fluid(s) and the color of the (clear) encasement of the bubble lamp can be subject to change. It is also expected that the rate and size of the bubbles can be subject to change. It is also expected that bubbles can be combined with lava lamps and the like. Also related to the light is another predicted concept; a (colored) clear candle container that (attempts to) get a prism effect from the flame. It is expected that one or more prisms would be present on it at locations where they are between the flame of the candle and the view of the flame. Also related to the light is another predicted concept; a lamp with such an encasement as that which is explained for the candle container.

Also related to the light is another predicted concept; a food dehydrater that uses lights instead of heaters. It is expected that such a dehydrater would be designed to work with one or more (conventional) (flourescent) light bulbs. It is expected that such a dehydrater would be designed with mirrored surfaces on the inside. It is also expected that the walls of such a dehydrater can be (tinted) plastic, the inside having a mirror finish the ouside without a mirror finish so as to allow external light in. Explained is the light dehydrater. Predicted is a dehydrater that uses both lights and heaters.

Also related to the light is another predicted concept; a light (with flexible armature) designed to be installed onto the battery of an automobile. It is expected that it can be designed to use the car battery as a power source. Also related to the light is another predicted concept, a razor (handle) with a built-in light.

Also related to the light is another predicted concept; an internal light (an L.E.D.) (that flashes as an indicator for incomming calls) for phones with clear or translucent encasements.

Also related to the light is another predicted concept; an ice chest with a built-in light. It is expected that the ice chest light can be designed to turn on automaticly when the lid is opened or removed. it is also expected that it can be designed to turn off when the lid is closed. It is also expected that it can be designed with a second switch to enable or disable the ice chest light.

Also related to the light is another predicted concept; a lense for flashlights and the like that contains one or more prisms. Size for the prism can be much smaller than the surface area of the lense. A decoritive effect for both the light and the output is expected.

Also related to the light is another related concept; a clear (colored) cover for lightbulbs and the like, all or part of which is in the form of one or more prisms. An expected embodiment is a solid heat resistant diamond shaped piece of soft plastic that can be slipped over a lightbulb.

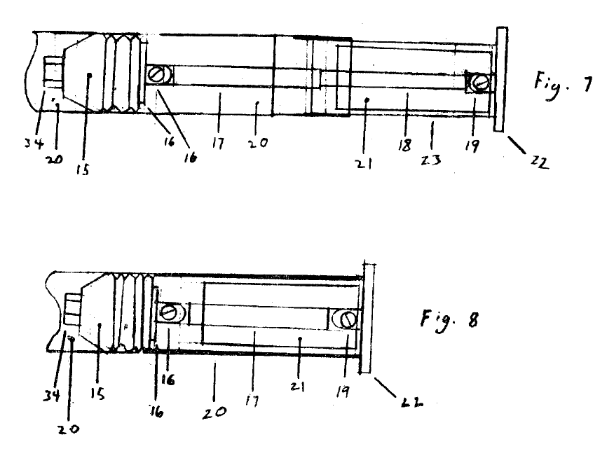

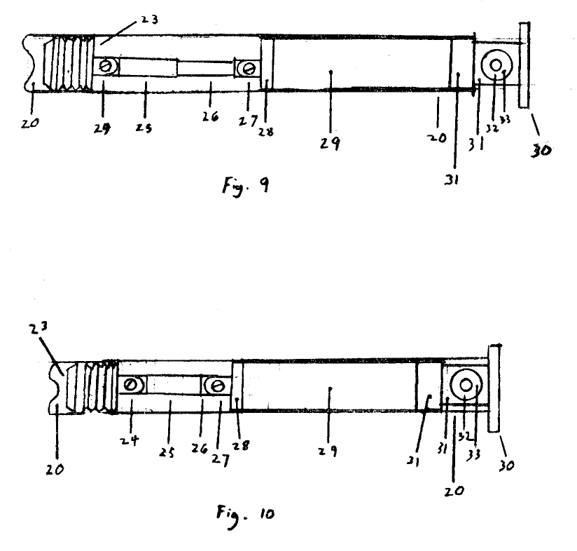

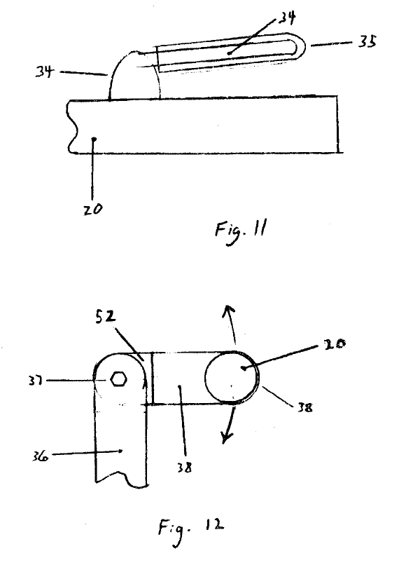

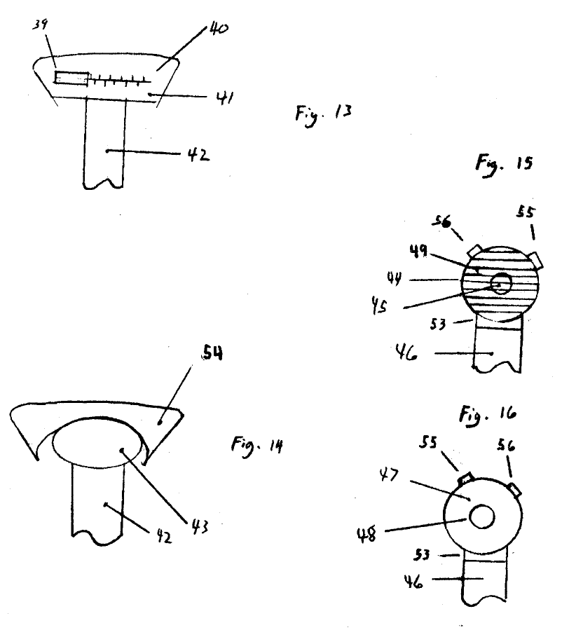

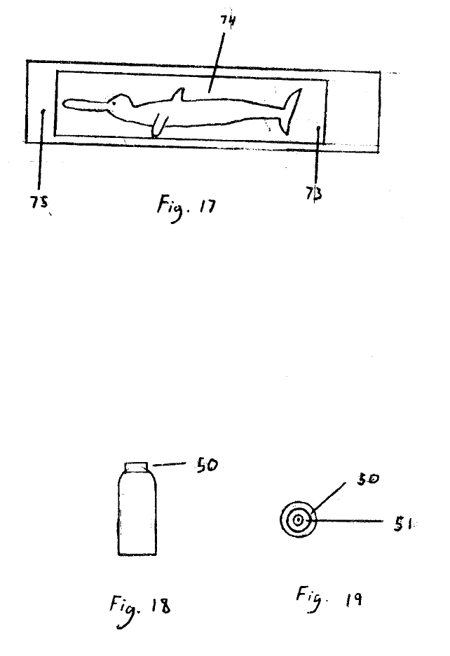

FIG. 5 is an enlarged cut-away view of the telescoping antenna 4-6. FIG. 6 depicts the telescoping anntenna. FIGS. 7 and 8 illustrates an example of the telescoping concept for the retractable handlebar mirror (Ser. No. 09/451,020). An apparatus that uses a button to deploy such devices is predicted. In FIG. 7 the retractable handlebar mirror is deployed. The embodiment is a handlebar with a rear-view mirror sticking out of it. In FIG. 8 it is retracted (pushed back into the handlebar for concealment). FIGS. 9 and 10 illustrate an example of the telescoping concept for the retractable handlebar light (Ser. No. 09/451,020). It is predicted that a fitting clear or reflective (like a bicycle reflector) plastic cap can be placed on the reflector. The cap can be red and the light can be pointed to the rear for use as a tail light.

In FIG. 9 the retractable handlebar light is deployed. The embodiment is a handlebar with a headlight sticking out of it. In FIG. 10 the retractable handlebar light is retracted (pushed back into the handlebar for concealment). It is predicted that the concept can be used for a container. Such a container would be extended out of the handlebar for access or pushed back in, using the cap, for concealment. Such a container is described as a removable device in handlebar devices (Ser. No. 09/451,020). Here-in it is described as a retractable device where as in handlebar devices is described as a removable device. It is expected that the method for retractable devices as described in handlebar devices and the added telescoping method as described here-in for the devices that are described as retractable can also be applied to other devices, some of which are in the prior art: U.S. Pat. No. 4,856,364 describes a radio; Said radio is not put forth as a removable or retractable device therefore the concepts for removable and/or retractable handlebar devices as described here-in do not apply. It is predicted that a radio can be in the form of the retractable devices or in the form of the removable devices of handlebar devices (refered to as the handlebar radio after such modifications) and that the telescoping method described here-in also can be applied to (other) such retractable devices. It is predicted that a radio can be an example of a device for which both the removable device concept and the retractable device concept can apply: It is predicted that the radio can be designed with the intention for capabilities of being pulled partially out of the handlebar for use while riding or pushed back in for concealment. It is predicted that the radio in such an embodiment can be designed so that it can also be (easily) removed from the handle bar for use elsewhere and then (easily) inserted back into the handlebar for concealment. It is predicted that all such devices can be in a format that is both removable and retractable as described for the radio (see part number 15).

Another predicted gadget (for bicycles and the like) is a plug-in speaker: It is expected that the described handlebar radio would be extended from the handlebar and the plug in speaker would be plugged into it. It is expected that the plug in speaker would be stored in saddle pouches. It is expected that that the handlebar cap of the handlebar radio can include two small holes through which the plug-in speaker can be plugged in. It is also expected that the handlebar radio can be designed to accept such a plug-in.

Another predicted device for the concept of handlebar devices is an alarm. It is expected that a battery operated alarm can be designed to fit in the handlebar. It is expected that it can designed using the reetractable and/or the removable device concept of handlebar devices.

It is expected that a turn signal light can be designed to work as a retractable device; the functional part of which can be pulled out of the handlebar for use and then inserted back into the handle bar for concealment. This described method is to be referred to as the retractable device method.

It is predicted that the concept can also be used for a retractable lock. It is expected that such a lock can be extended out of the handlebar for use or pushed back in using the cap for concealment. The device would remain installed when the lock is deployed. Such is the case with all devices of the retractable device method. The retractable lock would be designed with a stiff part attached to which would be a handlebar cap. The stiff part on one end would be attached to the stop 15 and on the other end and to the handlebar cap on the other end. It on the end near the cap would have a flexible hook to hold the lock in place. The lock would consist of a cable one end attached to a lock the other with a loop at the end. The loop can be hooked on to the unlocked lock or the hook and the lock can be hooked onto the hook. The other ends of the cable can be fed through holes in the stop. A bolt down mechanism to replace the stop is predicted. Such a mechanism can be found in the prior art; U.S. Pat. No. 5,950,498.

Another such device; a lipstick holder/device is predicted. The lipstick holder would be a device such as the removable devices of handlebar devices designed to (detachably) store lipstick and the like, concealed inside of the handlebar. It would be a device that can be removed from the handlebar for use and then inserted back into the handlebar for concealment. The expected embodiment is a rubber tube capable of holding a (lipstick) applicator with openings to access adjustment devices of the applicator. The tube would be of a size that generates such a fit with the inside of a handle bar so that it can be removed or inserted and can maintain positioning when inserted. It would have a handlebar cap on one end of it so that when it is inserted into the handlebar it is concealed. Another such embodiment is a device that is an applicator (for lipstick and the like) that is in the format of the removable devices of handlebar devices. The removable devices of handlebar devices include a container, a bottle, a writing device holder, a hairbrush and a comb. Such devices can be concealed inside of the handlebar. If reffered to as holder/device the device embodiment is a disposable or refillable device in the format of the removable devices of handlebar devices and as described here-in (next paragraph). If reffered to as device it is a device (such as a comb) (not intended as disposable) in said format.

The removable method as described in handlebar devices embodies a device such as a comb with a handlebar cap on it that looks the same as handlebar caps that can be purchased at bike shops. The device is designed to stay put in the handlebar when not in use. It is also designed with a cone on the end of it for easier insertion into the handlebar. The device is designed using a size that is as easy to insert or remove as possible while still retaining the ability to stay put in the handlebar. In an example; the device is pulled from the handlebar and the comb is used to comb the riders hair then the device is inserted back into the handlebar. It is then concealed because only the cap is showing and the cap looks the same as the handlebar caps that can be purchased at bike shops (as part of a foam handlebar grip kit). Also included for the concept is a handlebar grip that is designed to be as easily removed and replaced to/from the handlebar that has the removable device, in the example a comb, as part of it. The grip is illustrated in handlebar devices; FIGS. 46-49 in handlebar devices. Such devices can be designed to be removable and replacable.

The retractable method as described in handlebar devices embodies a device such as a rear-view mirror with such a cap the device is designed to stay put in the handlebar when not in use. It is also designed with a cone on the end of it for easier installation into the handlebar. The device is designed using a size that is as easy to deploy as possible while still retaining the ability to stay put whether in the deployed position or in the retracted position. In the deployed position; the device is pulled far enough out of the handlebar to expose the rear-view mirror. Enough of the device is left inside of the handlebar to enable it to retain its positioning when in that position. In the retracted position the device is pushed back into the handlebar so that only the cap is showing. It is then concealed in the same way as the removable device method.

Another such device a (sun tan) lotion tube holder is predicted. It would be like the lipstick holder; for lotion tubes and the like. A difference would be positioning for the tube inside of the device; room to squeeze it would be left. So the device can be designed to hold onto the lotion tube from the back. It is expected that the device can be designed with a means to bolt the lotion tube in. The device can include a holding tube that is soft enough so that it can be squeezed to extract the lotion in another embodiment. In this embodiment the lotion tube would be pushed further into the holding tube. Applicators and lotion tubes with a means to bolt on to such devices of fitting sizes are predicted.

Another such device; a lubrication dispencer holder/device is predicted. It is expected that it would be like the lotion tube holder for a container of lubricant for the gears. Related to the lubrication dispencer is another predicted concept; a modification for razers: A means for a lubricater that is in front of the blade instead of behind. It expected that the modification would comprise a removable hinged part in front of the blade(s) with a (replacable) roller of (solid) lubricant (such as soap). It is expected that the hinged part would be designed with round edges and that the described roller can be replaced with adhesive strips. It is expected that one or more springs would be used to maintian near level positioning (flush with the blades) for the hinged part.

Another such device; a lighter holder/device is predicted. It would also be like the lipstick holder, for (extended reach) lighters. The tube of the device that the lighter is pushed into would have openings for flame adjustment. Another such embodiment is a device that is a lighter that is in the format of the removable devices of handlebar devices; this device will be reffered to as the handlebar lighter. The handlebar lighter relates to another predicted concept: A telescoping retractable extended reach lighter. Such a lighter can be constructed using an outer telescoping conductive member to transmit electricity for the spark and an inner non-conductive telescoping hollow member with a nozzle to transmit fuel for the flame. Another way for such a lighter to work would include a telescoping hollow member to transmit said fuel and an apparatus containing a wheel that contacts a flint at the end of the tube. Such apparatuses are built-in to most or all disposable lighters.

The handlebar lighter also relates to another predicted concept: A pull-out barbeque igition apparatus. It is expected that the gas barbeque would be designed with a handle with a swith on it. The handle would be pulled out and the switch would be pushed to generate a spark from the ignitor. The handle would be connected to an ignition apparatus the spark generater of which is pulled into proxemity of the burner when the handle is pulled out. It is expected that one or more return springs would pull the handle back in when it is released. When the handle is pulled back in the spark generator is moved away from the burner. It is expected that such an apparatus would be less suseptable to heat damage; currently a common problem with conventional barbeque ignition apparatuses. Verticle movement for such an apparatus it also predicted.

Also related to the handlebar ligher is another predicted concept; a system built-in to such contraptsions as barbeques that douses the flame if the meat that is being barbequed catches fire. It is expected that such a system would be operable by means of a switch and/or automated. Also related to the handlerbar lighter is another predicted concept; a modification for barbeques and the like comprising a built-in lighter holder. Also related to the handlebar lighter is another predicted concept, a modification for barbeques and the like comprising a built-in charcoal lighter fluid container holder. Also related to the lighter is another predicted concept; a modification for barbeques and the like comprising a charcoal lighter fluid dispenser. It is expected that it can be designed to dispence fluid onto the charcoals.

Also related to the lighter is another predicted concept; a fireplace or similar contraption that is designed for easy installation. Hence forth reffered to as the windowsill fireplace. The window screen would be replaced with a new screen, hence forth reffered to as the windowsill fireplace screen, that is designed to accept and support the exaust pipe of the windowsill fireplace. It is expected that the part of the exaust pipe or chimney that fits through the supported openning in the windowsill fireplace screen and the opening would be rectangular to allow for maximum closability of the window at which the windowsill fireplace is installed. It is also expected that size for the windowsill fireplace can be smaller than conventional fireplaces.

Another such device; a match holder is predicted. It would be a removable device such as the removable devices of handlebar devices. It is expected that it would contain a clip or a clamp to hold one or more matches.

Another such device; a roman candle holder/device is predicted. It would be a holder with a handlebar cap on it capable of accepting a roman candle of a size that fits inside of the handlebar. It is expected that it can contain a loop with a tightening screw: It is expected that the roman candle would be slipped through the loop and the (finger tightening screw) would be rotated to securly hold the roman candle. A roman candle with a handlebar cap built onto it that is in the format of the removable devices of handlebar devices; is also predicted. It is expected that such a candle would be of a size that conforms to the concept of the removable devices of handlebar devices, this one would also be disposable. This relates to another predicted concept; a handle designed to accept roman candles. It is expected that it would be like a handlebar grip. It is expected that the outer end of it can be covered using thick enough and strong enough material to completely eliminate the possability of discharge in case the roman candle backfires.

The roman candle holder relates to another predicted concept; a candle that emits (a shower of) sparks while it's burning. It is expected that a candle with a sparkler (minus the handle) inserted next to the wick is a way of describing such a candle. It is expected that one or more devices such as (wood) sparklers (of variable sizes) can be used in conjunction with one or more wicks (of variable sizes) to change the effects. It is expected that the sparklers (and such devices) can be constructed with combustable material in place of the metal which is normally used. It is expected that a device that acts as both a wick and a spark generating device for such candles (that can be designed to be inserted into candles) can be manufactured. It is expected that a device can be designed for insertion into a candle that outperforms or performs differently than a sparkler; an example is a tiny fountain of sparks.

Also related to the roman candle holder is another predicted concept; a firework (candle) spark containment apparatus. A glass structure or container would be designed to contain sparks etc. emitted by fireworks to reduce or remove the fire hazards associated with lighting fireworks (indoors). Related to the handlebar roman candle is another predicted concept; a container for the spark emmiting candle that is designed to contain the sparks.

Also related to the roman candle holder is another predicted concept; a (fireplace) log that emits a shower of sparks while it's burning. It is expected that a (compressed) (fireplace) log can contain spark generating materials as a extra ingredients. It is also expected that firewood logs can be sold with a spark generating device inserted. Predicted is a device that is a nail that has spark emitting material on it. The spark emitting material can be like that of a sparkler. The tip would be larger in diameter that the rest of the shaft, the spark emitting material would be installed above the tip with the same diameter as the tip. This way the shaft complete with spark emitting material and metal tip would be of even diameter. The devices would be designed to be nailed into (fireplace) logs. One or more of the devices can be nailed into a (fireplace) log to convert it into firework log. Also predicted is a drill bit of a size for drilling holes in (fireplace) logs or candles that sparklers [or other such devices (designed for logs or candles)] can fit (snugly) into.

Another such device a survival knife holder/device is predicted. It would be like the lipstick holder for survival knives and the like that are small enough to fit into the holder. Another such embodiment is a device that is a survival knife or something similar in the format of the removable devices of handlebar devices; it will be reffered to as the handlebar survival knife. Related to the handlebar survival knife is another predicted concept; a chainsaw that is designed to be a meat carver.

Another such device; a breath spray apparatus holder/device is predicted. It would be like the lipstick holder for breath spray devices and the like. Another such device; a perfume spray apparatus holder/device is predicted. It would be like the lipstick holder for perfume spray devices and the like. Related to the perfume spray device is another predicted concept; perfume that is named after a type of flower (or other scent) that smells like that flower (or that other scent) that it is named after. An example is perfume called orchid that smells like an orchid.

Another such device; a mist bottle holder/device is predicted. It would be like the lipstick holder for mist producing devices and the like. Such a concept relates to another predicted concept; large scale machines that are capable of producing mist (for sunbathers). Such a machine would contain a tank and a motor, and a rechargable battery for apparatuses with electric motors, to develope pressure in the tank. Water under pressure in the tank would be delivered to one or more nozzles to eject mist. Such a contraption can include wheels for portability. Medium scale mist machines are also predicted. It is expected that such machines would be large enough to eject mist for multiple hours on a refill.

Another such device; a tire repair kit is predicted. It would include the neccesary parts for such a kit. It would be a container packaged with tire repair equipement, designed to be stored inside of the handlebar. It would be a device including a handlebar cap that can be removed from the handlebar for use and then inserted back into the handlebar for concealment.

Another such device; a (bicycle) pump is predicted. It would be a pump designed to fit inside of a handlebar that has a handlebar cap attached. Included on the pump would be a rubber part that is of the optimized size to hold the device in the handlebar yet allowing for removal from the handlebar and replacment back into. All such devices can be of such a size. The pump can be removed from the handlebar for use and then inserted back into it for concealment.

Related to the pump is another predicted concept; a holder for (inflation) adaptors (that is designed to be installed onto a pump). An example of an expected embodiment is a tie wrap with a funnel shaped part capable of accepting and securly holding a ball needle. The apparatus would be of a size that can be wrapped around and securly installed onto part of a pump. It is expected that ball needles and/or other (inflation) adaptors can be sold with such apparatuses. In another embodiment the holder can be designed for (protective) storage of (inflation) adaptors (seperate from the pump).

Another such device; a wheel lock is predicted. This device would be a lock that can be applied to a spoke to render the bicycle unridable. It would be a lock designed to fit inside of a handlebar with built-in parts including a rubber part as descibed for the pump, and a handlebar cap. This relates to a predicted combination lock for motor(cycle) igniton systems. Such a lock would be designed with the intention of connecting or disconnecting the ignition system circuit using a combination lock. An example would be a lock in the format of a conventional multi-wheeled bicycle lock. the wheels of the lock (normally designed with grooves that synchronize to form a trough when the correct combination is dialed) would be composed of metal. These wheels would contain protrusions that connect with a smooth circular elements. The circular elements can be composed of two materials one of them condutctive. When the correct number for a wheel is dialed the protrusion connects with the conductive part of the circular element. The conductive part of the circular element is wired to the next circular element at the location of the conductive portion. The location is subject to change to provide a plurality of combinations. The size of the conductive portion can be perportional to the numbering of the lock wheel. For instance, the lock wheel can be numbered one through ten. An example for a wheel would connect the protrusion to the conductive spot when the wheel is dialed to two. The two outer lock wheels can also have conductive protrusions on the outer sides that contact outer conductive plates regardless of positioning. The two outer plates can concect to the remainder of the ignition circuit. It is expected that for a vehicle such as an EV1 it can act as a theft deterant.

Another such device, a telescope is predicted. It is expected that it would be a rubber coated telescope or similar device with a cap on it that is designed to fit inside of the handlebar.

Related to the telescope is another predicted concept; telescoping binoculars. Also related to the telescope is another predicted concept, the addition of a flashlight [or other field (of view) illuminator] holder for binoculars and the like. It is expected that said holder would be designed to allow for easy removal and replacement of the field of view illuminator. Also related to the telescope is another predicted concept; binoculars or other occular device with built-in removable field of view illuminator.

All the devices disclosed a “another such device” can be additional removable devices for the removable device concept as described here-in and in handlebar devices.

Another predicted concept for bicycles and the like is an apparatus (either in the form of an extra seat or a trailer) for pets. It is expected that such apparatuses can be designed for pets. Related to the pet apparatus is another predicted concept; “scoby snacks” as a brand name for snacks (for dogs) (or in another embodiment, for people).

Other predicted bicycle gadgets include glow-in-the-dark handlebar grips, glow-in-the-dark handlebar caps and (glow-in-the-dark) pedal covers. it is expected that such covers can be pieces of strechable (foam) rubber with openings for the reflectors that are designed to be slipped over the pedals. It is expected that they would be of an elasticity and size that can be (easily) slipped over the pedal and able to retain positioning once installed. It is also expected that they can also be designed with tops that have finger like protrusions that can message the feet. This relates another predicted concept, a mat for the shower with such protrusions.

The pedal cover is related to a predicted device for skateboards and the like; a [(foam) rubber] (glow-in the-dark) cover for skateboard decks. Such covers can be embodiments (made of rubber) that are designed to be stretched over the boards. They would be designed to cover the top and the outer edge of the bottom of the boards It is expected that they can be designed with (disconnectable) straps that connect one side of the bottom of the cover to the other. It is expected that the covers would be of an elasticity that can be installed onto the boards and that retains poisitioning once installed.

Also related to the the embodiment of pedal covers with rubber protrusionsis another predicted concept; another such modification to such boards: (Glow-in-the-dark) tops with rubber protrusions (that serve to message the feet).

Another predicted (bicycle) gadget is a bottle designed to fit in a bicycle water bottle holder with a nozzle that ejects mist when the bottle is squeezed. It is expected that it can be designed with a tube that is connected to the nozzle and extends down into the bottle so that the bottle does not have to be tilted upside down for the ejection of mist. Such a bottle can be used elsewhere. This relates to another predicted concept; a (powered) mist ejecter for the inside of automobiles. Also related to the bicycle mist bottle is another predicted concept; a (mineral) water bottle designed to fit in a bicycle water bottle holder with a rock a or other such solid mineral in it. It is expected that the bottle would be designed so that the rock is contained in a cage and clearly visible. The bottle can display the words “mineral water” on it. It is also expected that such a bottle can also be intended for use as a water bottle.

Also related to the mist bottle is another predicted concept; the use of collapsable/expandable bottles for such beverages as soda as a means to preserve carbonation and/or freshness.

Another predicted bicycle gadget is squirt gun (with an adjustable nozzle) designed (for bicycles and the like) (to fit in a bicycle water bottle holder). The expected design would make the squirt gun look like it belongs with the bicycle.

Related to the squirt gun is another predicted concept; a gun that uses the equivelent of a lazer pointer and is also a lazer pointer: It is expected that it would be a lazer pointer in the form of a gun (that also is designed to be a gun for target practice). It is expected that it would be designed to project a spot (for a brief period of time in the gun mode) on what it is aimed at when the trigger is pulled. It would be for use as a pointer or a gun. Two seperate devices are also predicted (a lazer pointer in the form of a gun and such a gun as described).

Another predicted gadget for bicycles is an adaptor that replaces the front wheel for a conversion to an ice vehicle. The new adaptor would have two ice blades in parrellel to help keep the rider from falling. This concept is related to the double axle skateboard truck. The part of the skateboard truck that contains the axle can be easily removable in the current design for skateboard trucks. That part can be removed and replaced with the (winter sports) skateboard truck part; The double axled skateboard truck part. Such a part can be installed onto a skateboard Adapters; ice blades and the like [not excluding (water)ski adaptors], that are designed with two holes to fit on the double axle skateboard truck can be installed. The adaptors can be designed with a thickness for the holes so that they are immobile once installed onto the truck. The truck (parts) can be designed with two or more axles and the adaptors can be designed with two or more holes. The foam rubber deck covers as previously described can be used in conjunction with the truck parts and the adaptors. It is expected that skateboard trucks can be manufactured with double axles.

Also related to the double bladed ice adaptor is another predicted concept; skateboards (for the snow) designed with more than two (sets of) trucks. Placement for the trucks would be subject to change.

Another predicted gadget for bicycles and the like is a holder for wireless phones. Such a holder can use such means as elasticity and clamps to adapt to the different sizes of wireless phones. The holder can be designed for placement on the handlebar or the frame.

The phone holder relates to another predicted concept; a kit for cordless phones; The purpose of the kit would be to provide a switch to disconnect the battery for extended standby time. The embodiment of the kit would be a battery cover with a switch (on the outside of it) that is connected between a recepticle for the battery and a connector for the phone circuit. The battery is connected to the recepticle and the connector is plugged into the phone circuit then the cover is installed onto the phone. The extra circuitry excluding the switch would be designed to fit inside of the battery compartment. An optional resistor can be wired between the recepticle and the connector. The resistor can be used to allow enough current to retain stored numbers or other information for devices that retain such information using the main battery. An optimized resistance value to retain the stored (automatically dialed) numbers or other information and maximize standby time or other functions for the main battery would be expected.

Also related to the phone holder is another predicted concept; a predicted method of billing for wireless phones; (to remove the monthly fee that is associated with subscriptions) the phone company would charge the caller by the call. This would make the wireless phone like pay phones. One of the objects would be to replace pay phones with wireless phones.

Also related to the phone holder is another predicted concept; a modification for push button phones: One or more buttons and associated circuitry to dial area codes. It is expected that the buttons would be programable to dial area codes.

Also related to the phone holder is another predicted concept; a holder for (hand held) hair dryers that is designed to be pointed downwards. It purpose would be to dry number two occurences from pets that happen where they are not supposed to. It is expected that such occurences would be easier to clean if dried beforehand.

Another predicted gadget for bicycles and the like is a pocket p.c. (pda) holder. It is expected that it would be like the described phone holder.

Another predicted device for bicycles and the like is a bag that is of a shape that conforms to the shape of the bicycle. Such a device can be used to protect a bicycle when it is parked or stored agianst weather etc. Said bag relates to a new predicted concept; face bags. Face bags would be bags designed (including holes for eyes, mouth, etc.) to be worn on the head for the purpose of covering all or part of the face. They can be packaged in groups of one or more for over the counter sales. The packages can identify the product (as face bags).

Another predicted device for bicycles and the like is an (LED) clock for bicycles and the like designed to be mounted on the handlebar or another part of the frame. The clock can include mounting bracketry to enable it to be bolted to the handlebar. This relates to another predicted concept, the diode sticker; a sticker or (removable) decal of a color such as yellow that that can be placed on displays to change the color. For example, a yellow sticker can be applied to a blue LED display to change the color to green. It is expected that the embodiment can be a larger sticker that can be trimmed to the right size and shape for the display that it is intended for.

Also related to the bicycle clock is another predicted concept; a modification to clock with projectors that makes them like grandfather clocks: It is expected that such a clock can be modified to project the the time at predetermined or programable intervals (accompanied by chimes). It is expected that the a time projector and the modification can be added to grandfather clocks.

Another predicted device for bicycles and the like is fitness training computer. It is expected that such a device can be mounted like a bicycle speedometer. Such instraments can be found built-in to stationary bicycles at fitness clubs. Related to the fitness computer is another predicted concept; a scale that is designed to (more accuratly) measure (day to day) wieght fluctuations (for dieters): Said scale would be designed with a dial or a wheel that spins around many times when stepped on. The full scale reading would be much lighter than on conventional bathroom scales. An example of the full scale reading can be twenty pounds as opposed to a common value of three hundred pounds for conventional bathroom scales. The number of rotations can be counted to access total wieght. The primary function would be to access how much wieght (in ounces or smaller increments) was gained or lost in a given time period such as twenty four hours. Predicted is a window for the scale reading of scales that incorporates the use of a maginfying glass to accuracy.

Other predicted devices for bicycles and the like include an altimeter, a thermometer, a barometer, a humidity meter and a GPS. It is expected that all those devices can be embodied as individual units and that they can be built into a singular unit and that the unit(s) can designed for mounting on the handlebar or the frame. It is also expected that the unit can be designed to accept new devices. The fitness computer relates to another predicted concept; a computerized television media holder/player. It is expected that it would contain one or more hard disk drives or the like to store television media. The device would have capabilities of copying movies (and other television media) to a storage device(s) and showing the movies one or more at a time through TV sets. It is expected that it would contain a modem and software that can download movies. It is expected that such a device can be built into TV sets and the like. It is also expected that such a device can be designed to be upgradeable. One of the projected goals is a box that contains every movie ever made. It is also expected that such a device would be capable of recording movies (writing them to hard drive) from the media. Such a device is also predicted for video games it would be a video game system that stores video games. Such a device is also predicted for music. Also predicted is such a device for video games music and movies or any combination of two of the three. It is expected that the movie device can be designed to assign one or more dates to each movie that it plays. This is a way of keeping track of when the movies were watched. Other means are predicted to keep track of when movies are watched.

Also related to the fitness computer is another predicted concept; a surge protector that is designed to connect components together using the ground pin of the power plug. The surge protector and the components would be wired so that plugging them into the surge protector connects the inputs and the outputs of the components together. Also related to the fitness computer is another predicted concept; a website that gathers opinions about movies, t.v. programs and the like.

Another predicted concept for bicycles and the like is a suit designed with intentions of water proofing: A single piece, zippered, head covering suit composed of a water resistant material is expected. This relates to another predicted concept; a motorcycle windshield wiper/washer and a (motorcycle) helmet with built-in wiper/washer.

Also related to the waterproof suit is another predicted concept; a shirt or other article of clothing with an embodiment of a (big) (fake) (removable) (potato) chip on the part of it that covers the shoulder (as a halloween costume). Also expected is an embodiment of the word “chip” (or other wording) on (or in the vicinity of) the shoulder for such articles of clothing.

Other predicted concept for bicycles and the like include an (smaller) embodiment of Mister Potato Head and a figure of a potato with glasses both of which are designed as decorations for the handlebar. Related to this are other predicted concepts; a (smaller) embodiment of Mister Potato Head and a figure of a potato with glasses both of which are designed to as antenna decorations. Also related to the antenna decorations are other predicted concepts; other embodiments of both Mister Potato Head and a potato with glasses, stuffed embodiments (like stuffed animals) and ceramic figures (for the household) for instance. It is expected that the potato with glasses can include identification as a spectator. Also related to the handlebar decoration that is a figure of a potato with glasses is another predicted concept; glasses that are designed to fit on (real) potatoes.

Another predicted concept for bicycles is the use of the word “generic” as a brand name. It is expected that generic can be a brand name for anything to which a brand name is applied. It is also expected that generic can be a substitute brand (product name/number) name. An example of a subtitute brand name for generic is “generic w” as a brand name in which generic w is a duplicate product of the product of brand name w. The example of brand name w in this hypothetical can be a famous brand name. In another examaple of generic as a substitute brand name and product number is “generic w 1” in which w is the brand name and 1 is the product number for the product called 1 by the w brand name. It is expected that the products etc. of brand name generic (as a substitute brand name) can be advertised as and made the same as the products of the (famous) brand names that generic is being used as a substitute for. It is also expected that the products of brand name generic can be advertised as being and made the same as likewise (famous) brand name products.

Another predicted concept for bicycles and the like is a basket with a built-in drink or bottle holder. It is expected that it would comprize a circular piece of flexible (stretchable) material bolted to the inside (or the outside) of the basket. It is expected that it would be of a size that conforms to bicycle water bottles.

Related to this is another predicted concept; A rotissorie basket. It is expected that it would be a (wind-up) rotissorie designed as a stand alone unit for the inside of cooking apparatuses that is capable of withstanding the heat. It is expected that it can contain an adjustable basket conformable in size.

Also related to the drink holder is another related concept; a basket with foldable legs that is designed for use as a fry basket or a steam basket. It is expected that it would include an apparatus for a (snap-on) detachable handle. Its purpose would be to convert an ordinary sauce pan or other cooking apparatus into a steamer/deep fryer. It is expected that it would be available in a variety of fitting sizes to conform to different sized sauce pans. Covers designed for sauce pans for storage (of frying oil such as those currently coupled with small deep fryers are also predicted). Also predicted are proprietary cooking apparatuses that are designed as combination steamers and fryers using such baskets and covers.

Also related to the drink holder is another predicted concept; a holder that is designed to store one or more bottles or other containers upside down. It is expected that it can be designed with an adjustable mechanism(s) to accommodate different sized containers. It is also expected that it can also be designed not to tip over. Another predicted concept for bicycles and the like is a basket with a built-in pouch or other container. Also related to the drink holder is another predicted concept; a barbeque with (multiple) built-in drink holder(s). Also related to the drink holder is another predicted concept; a barbeque with a built-in holder for a fire dousing device (squirt gun or related device).

Another predicted concept for bicycles and the like is a (removable) device containing a (large) wind-up apparatus that can (easily) be engaged or disingaged. It would be a device that can be wound by the turning of a wheel or sprocket and acts as a motor to turn said wheel or sprocket It is expected that it would be on an apparatus that enables it to be turned around and re-engaged to the wheel to enable it to spin the wheel forwards. Related to the wind-up bicycle motor is another predicted concept; a car or other related vehicle with a wind-up motor.

Related to the wind-up bike motor is another related concept; a skateboard with a wind-up motor: It is expected that the wind-up skateboard motor, the wind-up car motor and the wind-up bicycle motor can be designed to be compatible with a predicted apparatus that uses an electric (a.c.) motor to wind them.

A predicted concept for bicyclists is the bicyclist report: Such a report would disclose information for bicyclists. An example of such information that is not included in normal weather reports can be a statement that the wind is expected to shift directions. Such information can be important to bicyclists because it can be favorable to ride with the wind on the way back.

Related to the bicyclist report is another predicted concept; a report for nightclubs and the like that discloses information about the patronage: The expected information is a count of the percentage of (single) female customers. It is expected that other aspects about the patronage can be included. It is expected that the report (reffered to as “the bar report”) can be sold as a seperate document or as part of other publications (newspapers and the like). It is expected that information for the bar report can be gathered by such means as the use of one or more reporters. In another example of information gathering means the establishments do the reporting.

Another predicted concept pertaining to bicycles is a bicycle (buyers) guide: Such a publication can include pictures, specifications, (suggested) (retail) prices (and other information) for (currently available) bicycles. Related to the bicycle buyers guide is another predicted concept; a book that translates normal english into a Shakespearean format. It is expected that it can include a Shakespearean dictionary and lists of commonly used fraises. Such a format can be found in conventional language to language translaters. Also predicted is such a translater for “jive” as put forth in the movie airplane. It is expected that the translating books can be in a format that teachers such linguistics to the reader. It is expected that they can contain translated dictionaries and translated lists of commonly used fraises. Also related to the bicycle buyers guide is another related concept; a list for the language translating dictionaries of language translating books (including the ones listed here-in) of the most commonly used words Such a list (in sequence) is predicted for such books that is designed for optimum performance in the learning of the language. It is expected that such books can be aimed at teaching pidgeon or other rudamentary means for communication. It is also expected that such books can explain how to learn the language by memorizing one or more words (including the word and its translation) (from said list) per day. It is also expected that they can project calculations as to the length of time it would take to become (partially) fluent if predetermined rates of memorization are followed. It is also expected that such books can contain information about (scientific) techniques for memorizing words and thier meanings. The cover of such a book can state that it is the best book obtainable for the learning of a language. Predicted is an embidiment of said list (and other information listed here-in) on a single sheet of paper.

Another predicted concept pertaining to bicycles is a calender with pictures of bicycles on it. It is expected that it would be like the commonly available calenders that contain pictures of exotic cars. An example is to replace the pictures of cars with pictures of (exotic) mountain bikes. Related to the bicycle calender is another predicted concept; a format for (scenic) calenders: The (time) and date of the pictures would be documented. In an example, the corresponding pictures would be taken on the fifteenth of the month in the corresponding month and it would be documented on the calenders that the pictures were taken on that date. For instance the picture for the month of january would be taken on the fifteenth of january and it would be documented on the calender when it was taken. It is expected that such pictures can be seasonal in appearence. It is expected that any publicized (outdoor) picture, postcards for instance, can follow such a format.

Also related to the bicycle calender is another predicted concept; (seasonal) (scenic) calenders containing pictures of natural phenomina. Also related to the bicycle calender is another predicted concept; post cards and the like with such pictures. It is expected that the described pictures for (scenic) (natural phenominum) calenders and post cards and the like can contain (human) subjects (beautiful women for instance) and/or (wild) animals.

Another predicted concept pertaining to bicycles is a key ring or key chain orament in the form of a bicycle. It is expected that other vehicles can be used for such a key ring.

FIG. 11 illustrates an example of the brake grip. FIG. 12 illustrates an example of an adjustable handlebar mount; it is an embobiment of the tilt handlebar. FIG. 13 illustrates an example of the bicycle seat pouch. FIG. 14 illustrates an example of the bicycle seat tail light. FIGS. 15 and 16 illustrate an example of the reversable front reflector light. FIG. 17 illustrates an example of the bicycle sticker. FIGS. 18 and 19 illustrate the sports bottle battery.

1. Handle 1 can be a piece of plastic. It would serve as a handle for bidirectional or left side deployment pop-out rear-view mirrors. For the displayed embodiment, it serves as a decoration (to make the light look symetrical). Such a decoration/handle is also needed for a new predicted toilet paper holder. In this concept; on one side is a handle that also serves as a decoration, on the other side is a decoration 2 that looks like the handle to make the device look symetrical. For this concept; the decoration can be subtractable and subject to changes in characteristics. The two sides can be related embodiments. The handle for the toilet paper holder would be used in the same way as the handle of the pop-out rear-view mirror. It would be part of an embodiment that includes a shaft that acts as an axle for the toilet paper roll. Said handle shaft embodiment would be pulled from the toilet paper holder to remove the spent toilet paper roll. For new roll installation; the toilet paper roll would be held in place and the handle shaft embodiment would be inserted through a hole (the first part of which a funnel shape for easier insertion, the second part a precision fit tube to guide the toilet paper rod to a recepticle on the other side of the holder) into the holder through the cavity of the toilet paper roll. The end of the shaft is expeceted to be round to allow for easier insertion into the (bowl shaped) recepticle in the other end of the holder. The embodiment is a toilet paper holder that securly holds toilet paper rolls having likewise exterior decorations, one of which is also a handle, on each of the two sides. Such holders for other types of (paper) rolls are predicted.

Also related to handle 1 is another predicted concept; a handle for (disposable) razors. It is expected that it would be designed so that a disposable razor can be inserted into it. Its purpose would be to provide a better handle for disposable razors. (It is expected that said handle would be like those of more expensive razors.) It is expected that such a handle can have a built-in light.

2. Handle 2 can be a handle. It can serve as a handle (for the pop-out mirror). It is illustrated with an image (that resembles the U.S. flag). Size and shape can be subject to change, areodynamic shapes and shapes that embody resemlences are not excluded. Either side can be a handle or a decoration and vice versa etc. Devices with multiple handles (and such decorations) are predicted.

Related to the embodiment of an areodynamic shape for the handles (triangles for instance) is another predicted concept, a storage container for the back of the bed of pick-up trucks that is triangular in shape (wedge shaped). The shape would be a three dimentional elongated triagle. It would be of a width that is approximately the same as the inside of the truck bed. If placed in the back of the truck bed it is expected that it would increase gas milage by channeling wind above the gate while aslo acting as a trunk. A means for bolting it removably to the back of the truck bed is predicted. It is expected that hieghth in order to maximise milage would be equivalent to the hieghth the truck bed gate. Another embodiment for the concept (thought of as “the pick-up truck triangle”) is a flat piece of solid material, such as plastic, that is designed to be placed on the gate. It is expected that it would be designed with hooks that fit snugly over the gate; The would be slipped over the tailgate and the plainer member would extend from the top of the tailgate to the bed. The plainer member would be of a width that is approximatly equal to the width of the tailgate. This emodiment would serve the purpose of increasing milage. A means to securly bolt the plainer member to the tailgate (clamps for instance) is predicted.

Also related to the embodiment is another predicted concept; a bodyboard leash plug with a more areodynamic shape for the part that is external to the underside of the bodyboard, currently a circle is used. An isocolese triangle is an example of a more areodynamic shape. It is expected that said part would be designed with a means to hold its positioning; cone shaped protusions that dig into the underside of the bodyboard.

3. Screw can be a screw.

4. Large antenna section can be a piece of plastic. One end of it is bolted to the first antenna swivel 7, the other end of it connects to the meduim antenna section 5, in the same manner that the sections of a telescoping antenna for a portable radio connect when the antenna is deployed. The telescoping antenna (FIG. 6) operates in such a manner. It is expected that such an antenna can also be used as an antenna and as described here-in for the predicted removable/retractable handlebar radio as previously described: Said antenna would be connected to the antenna circuit of the radio. It is expected that the removable/retractable handlebar radio, as described can be designed with openings to improve reception when used as a retractable handlebar device in such a format also using the telescoping antenna as a radio antenna. It is also expected that the telescoping antenna of FIGS. 4, 5 and 6 in a metal embodiment can double as a radio antenna for an embodiment of the light 12 (or other device) with a telescoping mirror and a built-in radio.

Such devices are predicted.

The mechanisms such as the telescoping antennas described here-in for the telescoping mirror also used as a radio antenna relates to another predicted concept; a stand for (hand held) television sets. It is expected that such a stand would be designed with a pod with three or more legs and a holder such a the one described for wireless phones. It is expected that the stand would include a telescoping mechanism such as the telescoping apparatuses described here-in, connected between the pod and the holder. It is also expected that swivels, such as the ones described here-in can be connected between the pod, the telescoping mechanism and the holder. The swivels would enable adjustability in positioning for the television set. It is expected that the stand would be designed using folding parts with the intention of maximum foldability: To fold into as small a device as possible. It is also expected that the (telescoping part of) the stand can be designed with the intention of acting as an antenna: A cable with an adaptor for the television set would be connected to (that part of) the stand.

The described use of said radio antenna also relates to another predicted concept: The use of two or more TV antennas on one (or more) antenna poles. The outputs of each antenna would be combined to increase signal strength. Another predicted concept is also related: The design of automobiles with two or more radio antennas to improve reception. It is expected that the design can be with the intention of making the vehicle look more attractive. Another predicted concept is also related to the radio antenna: Antenna repeaters; such a circuit would be either a stand alone device or built into audio/video equipement. It is expected that the repeaters would increase the signal for telesion or radio stations. The embodiment would be a repeater circuit that uses the consumers antenna to recieve, and transmit signals. It is expected that the circuit would amplify said signals before transmitting. The goal of such a concept is to enable the consumer to recieve stations from very far away as competion agianst cable and the like and so it is expected that many more channels would be added to the spectrum and that no two stations would be on the same channel.

Another predicted concept is also related to the radio antenna; a computer that is designed to enhance weak television signals or other radio waves. It is expected that it would be a (dedicated) upgradable computer that accepts software upgrades. It is also expected that such equipement can be designed into audio/video equipement.

Another predicted concept is also related to the radio antenna: An antenna switch for the base unit of a cordless phone system: The base unit would be designed with an (external) switch between the radio circuit and the antenna to provide a means to connect or disconnect the antenna. One of the purposes for such a switch would be a means for security. It is expected that the switch can be automated. Another predicted concept is also related to the radio antenna: Antenna extensions; such devices would be designed to clamp onto existing antennas to increase reception The expected embodiment is a (telescoping) rod designed with a clamp that can be clamped onto an antenna. It is expected that said antenna extension would include a means to connect to the antenna line (a two in one out cable connecter. The radio antenna relates to another predicted concept; a (clear plastic) ball with one or more wires (as antenna elements) (ridgedly) connected inside of it to an external antenna connecter. The radio antenna relates to another concept; a decoration for a UHF loop (in the form of a happy face). It is expected that such a decoration can be a (circular) piece of plastic glued into the loop. Areodynamic shapes and the like are not excluded.

Related to the radio antenna is another predicted concept; a modification for SETI. Currently SETI searches for signals from extra-terrestrial civilizations. It seems that SETI doesn't send signals for extra-terrestrial civilizations to recieve. It is expected that if SETI were (attempting to) send and recieve such signals the chances of recieving such a signal would increase. It is also expected that technical information can be sent out in hopes of recieving (more advanced) technical information (in return). It is expected that transmitting equipement would be modified so that such signals can be transmitted to such vast distances. It is also expected that recieving epuipement would be modified to be able to recieve said signals from such distances.

Related to the radio antenna is another concept for SETI; a giant television antenna in space. It is expected that if the antenna is big enough (perhaps trillions of elements) it can recieve detectable signals from extra-terrestrial civilizations. A filtration system to filter terrestrial signals would be expected.

5. Medium antenna section can be a piece of plastic.

6. Small antenna section can be a piece of plastic. One end of it connects to the medium antenna section when the pop-out mirror is deployed. The other end of it is connected to the second antenna swivel.

7. First antenna swivel can be an antenna connecter. The first and second antenna swivel; 14, can be antenna containing swivels of the type that can be found on portable radios. They are needed so the angle of deployment for the pop-out mirror can be changed. When deployed the (elevation and lateral) positioning can be subject to change. It is expected that the antenna swivels listed here-in can be tight enough swivels so that they can retain positioning.

8. Mount can be a connecter for a removable bicycle light.

9. Mirror can be a mirror. It can be glued onto the mirror caddy; 11. Related to the mirror is another predicted concept; a shower mirror on flexible armature that is designed to be bolted onto the shower rod. The intention is to design an apparatus that can be positioned out of the out of the way when not in use.

10. Mirror compartment can be a compartment. It can contain the pull out mirror apparatus 3-7, 9, 11. When the pull-out mirror apparatus is retracted, only the second handle is visible.

11. Mirror caddy can be a piece of plastic.

12. Light can be a bicycle light. The battery compartment is modified to accept batteries from cordless phones. The use of wireless phone batteries is predicted. Related to the light is another predicted concept; lanterns, all or part of which are of a green color. It is expected that such lanterns can (also) be designed to emit a green light. It is expected that such lights can (optionaly) say “green lantern” on them.

13. Compass can be a (glow-in-the-dark) compass. Them item can be optional.

Compasses (that are not built-in to a light) for bicycles and the like, compasses for ski equipement and the like (not excluding skateboards), compasses for camping equipement (excluding portable radios with built-in lights) and compasses for other sports equipement are predicted. It is expected that all such (glow-in-the-dark compasses) can be built-in or packaged (as part of a kit) so that they can be added to existing products (that don't already have built-in compasses). Included is the glow-in-the-dark-compass; such compasses can replace any existing compass that is allready built-in to a device.

14. Second antenna swivel can be another antenna connector, like the first antenna swivel.

15. Stop can be a piece of rubber. It can be of a size that generates a tight enough fit with the inside of the handlebar so that it is not subject to changes in positioning due to vibration or other tubulence. The fit can be so that positioning changes do not occur as a result of the deploying and retracting of retractable handlebar devices such as the retractable handlebar mirror. The stop can be designed with intentions that it stays put once the device is installed. It is expected that an imbetween the fit of which is still tight enough for the retractable devices would be used for devices that are to be designed as both removable and retractable as described here-in.

16. Third antenna swivel can be another antenna connector like the first anntenna swivel. In the case of FIGS. 7 and 8 it is shown bolted into the stop.

17. Second large antenna section can be a piece of plastic. One end of it is bolted to the third antenna swivel, the other end of it connects to the second small antenna section when the retractable handlebar mirror (15-19, 21-23, 34) is deployed. The fit between all of the antenna sections listed here-in can be subject to change. An attempt at an optomised fit is expected. An optomised fit is as easy to extend as possible while still tight enough so that positioning for the deployed device is not subject to changes due to vibration or other turbulence.

18. Second small antenna section can be a piece of plastic. One end of it connects to the second large antenna section when the retractable mirror is deployed. The other end of it is bolted to the fourth antenna swivel 19.

19. Fourth antenna swivel can be another antenna connector like the first antenna swivel. It can be part of the handlebar cap 22. It is expected that larger sizes may be needed to prevent breakage.

20. Handlebar can be a handlebar. The devices of handlebar devices can be used with any hollow handlebar.

21. Mirror can be a mirror. It can be glued onto the second mirror caddy. The angle at which it is glued can be subject to change.

22. Handlebar cap can be a handlebar cap. It can have the appearence of a conventional handlebar cap when the handlebar mirror is retracted. The handlebar cap, the fourth antenna swivel and the mirror caddy can be a singular piece of plastic. Predicted are glow-in-the-dark (handlebar) caps and glow-in-the-dark (handlebar) grips. Related to this is another concept; glow-in-the-dark switches for lamps, flashlights etc.

Related to the glow-in-the-dark handlebar grip is another prerdicted concept; a shower water control dial/handle with a protrusion. The protrusion would be used as a handle for temperature and water pressure adjustments. Also predicted is a foam rubber grip for said protrusion.

Related to the glow-in-the-dark handlebar grip is another predicted concept: a (glow-in-the-dark) (foam rubber) grip for handheld shower nozzles.

Also related to the glow-in-the-dark handlebar grip is anothr predicted concept; a (glow-in-the-dark) (foam rubber) grip for (disposable) razors.

23. Second mirror caddy can be part of the handlebar cap. It can be of a size that generates a precision fit with the inside of the handlebar. An attempt at optomization for the fit is expected as with the antenna sections.

24. Fifth antenna swivel can be another antenna connector like the first antenna swivel. It can be part of the second mirror caddy 23.

25. Third large antenna section can be a piece of plastic. One end of it is bolted to the fifth antenna swivel. The other end of it connects to the third small antenna section when the retractable handlebar light (23-33) is deployed.

26. Third small antenna section can be a piece of plastic. One end of it is bolted to the sixth antenna swivel.

27. Sixth antenna swivel can be another antenna connector like the first antenna swivel. It can be part of the lid 28.

28. Lid can be threaded piece of plastic. The retractable handlebar light can be extracted from the handlebar and the lid can be unscrewed from the battery compartment 29 to replace the batteries.

29. Battery compartment can be part of the retractable handlebar light. It can house the battery and some of the associated circuitry that connects to the light bulb. The plans for such a device are explained in handlebar devices. The associated part number in handlebar devices is 10.

30. Second handlebar cap can be a handlebar cap. It can have the appearence of a conventional handlebar cap. The light module and the second handlebar cap can be a singular piece of plastic.

31. Light module can be part of the retractable headlight. It is explained as part number 11 in handlebar devices.

32. Light bulb can be a (flash) light bulb. It is explained as part number 27 in handlebar devices.

33. Reflector can be a flashlight reflector. It can be glued into the light module. It is explained as part number 13 in handlebar devices. It is expected that a fitting (red or yellow) piece of plastic can be installed the reflector. The light can be spun around to face to the rear so that it can function as a tail light or a turn signal.

34. Brake handle can be a (gold plated) handlebar brake handle and the remainder of a handlebar brake. It is expected that such parts can be plated with or composed of precious metals and the like.

35. Brake handle grip can be a piece of (foam) rubber that fits securly over the brake handle for bicycles and the like. Predicteed is such a grip for gear shifters. The relates to such a predicted grip for toothbrushes. It is expected that such grips can be composed of glow-in-the-dark material.

36. Frame can be the part of a bicycle frame that the the handlebar holder 38 bolts onto.

37. Handlebar bolt can be a bolt that bolts the handlebar holder to the rest of the frame. Quick release mechanisms such as are common on bicycles in place of the handlebar bolt are predicted. The bolted can be loosened and the angle of the handlebar holder can be changed and then the bolt can be tightened so that the handlebar holder retains the new position.

38. Handlebar holder can the part of a bicycle (normally parellel with the ground) that the handlebar is bolted into. It can be designed with an elongated halfdisk shaped end 57 containing ridges that fits snugly into a fitting ridged slot on the frame. Explained is the tilt handlebar.

39. Zipper handle can be a zipper handle.

40. Zipper can be the remainder of the zipper. It can be used to open and close the bicycle seat pouch.

41. Bicycle seat can be a bicycle seat with a built-in pouch. Related is another predicted concept: Insulated duffel bags and back packs. The intention is to create a device that retains its usefulness (as a duffel bag or a backpack) and can also be used as a cooler. It is expected that thin and/or flexable enough insulation can be used so that the devices retain the (normal) flexability associated with such items. It is expected that the concept can be applied to other types of luggage or baggage. Related to the bicycle seat is another predicted concept; a modification for recliner chairs and the like: A built-in compartment with a drainage system that is designed to accept ice. The modification would be designed as an (optional) cooling system for the chair. Other predicted concepts that are related to the bicycle seat are modifications to recliner chairs and the like including; built-in fans, built-in air conditioners (the chair conditioner), and built-in machinery for power positioning adjustments (like power adjustable seats currently present in some cars). Also related to the seat is another predicted concept; a (recliner) chair with (retractable) built-in video game (controller) equipement. It is expected that such controllers would be built-in in such a way as to eliminate the need for hand held controllers.

Related to the seat is another predicted concept; a (recliner) chair or other furniture with a built-in projector. Expected are two uses for such a projector; a (t.v. or computer) monitor and a projector clock. Built-in (audio and/or computer) equipement for furniture is also predicted.

42. Seat stem can be a bicycle seat stem.

43. Seat light can be a built-in part of a (bicycle) seat 60. It can be a (tail) light that doubles as a reflector like the tail lights that are also tail reflectors currently common on bicycles.

44. Reversable reflector light can be a front reflector with a built-in light on one side and a head light on the other. An example of such a reflector light is common on bicycles. The tail reflector can be replaced with a reflector that doubles as a tail light. FIG. 15 shows the reversable reflector light in a position from which it is a front reflector with a built-in light. Said built-in light can be optional. FIG. 16 shows it in a position from which it is a headlight.

45. Bulb can be a light bulb or a light emitting diode.

46. Reflector bracket can be a tubular bracket for the reversable reflector light. It can serve as an axle for the wheel 59. It can be bolted to or a part of the frame.

47. Second reflector can be a mirror finish piece of plastic. Such reflectors are common on headlights.

48. Second bulb can be a light bulb. The use of light emitting diodes for headlights for bicycles and the like, cars, is predicted.

49. Front reflector can be a front reflector can be a conventional bicycle front reftector. The addition of a (magnifying) lense at the center is predicted.

50. Top can be the illustrated disk shaped portion of the sports bottle battery. It is expected that the sports bottle battery can be designed to look like a bicycle water bottle. This would help to conceal it identity as a battery [for a (concealed) electric motor located elsewhere on the bicycle]. It is expected that a conventional bicycle water bottle cap can be placed on it to further hide the identity of the sports bottle battery. The sports bottle battery would be designed to fit in a bicycle water bottle holder and for use for bicycles with electric motors. Related to this is another predicted concept; a drink holder for cars that incorporates the use of a bean bag to reduce the tendency to fall over. It is expected that a bean bag large enough to resist tipping over would surround the cup holder portion. It is also expected that the apparatus can be designed with the intention of resisting spillage. It is also expected that the cup holder portion can be designed to also accept bottles and the like. It is expected that a connecter can be wired from an electric motor so that the sports bottle battery can be used (as a back-up battery) for the motor. Related to this is another concept; (a vehicle with) a motor designed with switches to enable or disable (connect or disconnect to/from the distributer) the spark plugs. It is expected that such switches can be wired in the vehicle so as to be easily accessable to the driver from the driver's seat. The goal is to increase gas milage.

It is expected that such a battery as the sports bottle battery can be used for bicycles with electric motors and the like. Enlargement of the holder and the battery is predicted. An electric vehicle designed for use with such a battery can be sold without the battery and a voucher for a used charged up battery can be part of the purchase. The voucher would be used at a (gas) station. This way the motorist does not have to part with a new battery to get a refill. It is expected that such a battery as the sports bottle battery would be very easy to remove and replace. (Gas) stations would be exchanging charged (used) batteries for discharged (used) batteries for a price. This concept is (also) predicted for electric cars and the like. It is expected that such automobiles would be designed so that the battery(s) are as easy to replace as possible. Batteries with handles, batteries with wheels or track balls, and snap-in batteries are also predicted for the electric automobile and other electric vehicles. It is expected that hydraulics and the like and conveyors and the like would be used to swap the discharged batteries for charged batteries. The (gas) stations would exchange discharged batteries for charged batteries for refills for electric vehicles. The vehicles would be sold with (used) batteries or with said vouchers. Explained is a quick refill system (to exchange used dischared batteries for used charged batteries for energy refills) for electric vehicles. It is expected that such vehicles can be designed with (built-in) (removable) back-up batteries (big enough to get from the dealer to the station). Predicted are electric vehicles with multiple batteries. Also predicted is a (feul or voltage) meter for electric bicycles and the like. Also predicted is a removable battery for electric vehicles with a (such a) built-in meter (that can guage the integrity of the battery).

Related to the sports bottle battery is a predicted concept: A device that uses conventional (cylindrical) batteries to jump start a car. The device would include a charge up circuit such as that of a convetional battery operated camera flash system. Such a system would charge the circuit until an indicater such as a flashing light signals that sufficent current can be supplied to start the vehicle. The device would have cables long enough to reach from the vehicle battery to proxemity of the motorist in the driver seat. It is expected that the circuit would flash a light then the motorist would push a button on the device to discharge the circuit while in proxemity of the same time turning the vehicle ignition switch to start the motor.

Another concept for bicycles and the like is predicted; a wind turbine for electric bicycles. It is expected that a propeller driven wind turbine can be made small enough to fit onto the handlebar of an electric bicycle. The propeller would spin a generater and the generater would charge the battery for the motor. It is expected that the apparatus would be foldable into an areodynamic shape for times when it is not in use. Using the turbine would increase range for the electric motor. Such a turbine for other electric vehicles is also predicted.

Related to the turbine is another predicted concept; a power fan with the word “sports” on it. In another embodiment the fan would have team names colors (and the city for which the play) on it. In still another embodiment the fan would have the name of a sport and/or an illustration of sports equipement. Other such embodiments include the names (of professional athletes, rock stars etc.). Another concept for such a fan is the use of words that spell the names of or illustrations of food on it.

Predicted concepts to create special effects for fans while the fan propeller is spinning are also related to the turbine: An effect would be created by using blades of different (flourescent) colors in an attempt to blend the colors when the propeller is spinning. For instance a four blade fan propeller would contain two yellow blades and two blue blades; a green effect is expected when the propeller is spinning. Another effect would be created by using one or more reflectors on one or more of the blades. Another effect would be created by using a (colored) mirror(s) on (one of) the blades. Another effect would be created by using lights on (one of) the blades. A holder built onto a fan blade(s) for (bicycle tail) lights is predicted. Another would be created by using a (glow-in-the-dark) (marbled) (colored) spot(s) on (one of) the blades. It is expected that another effect can be created by developing a means to attach a sparkler to (one of) the blades; a sparkler holder. Also predicted are holders for other types of fireworks and holders for incence and punks another gadget for such fans is a whistle. Predicted is the use of marbled colors on such a fan. Also predicted is the use of colored mirror finishes. also predicted is a fan all or part of which glows in the dark. Also predicted is a clear grill with one or more prisms on it. Also predicted is a fan motor of low enough torque so that it is safe to stick one's hand into the propeller while it is spinning. It is expected that a fan with such a motor can be sold without a grill.

Also related to the turbine is another predicted concept; an attempt at weakening or stopping hurricanes or other such storms: One or more supersonic aircraft would circle the perimeter of the eye of the storm in the opposite direction of the rotation of the storm. It is expected that if enough aircraft are used similaneously the storm would weaken or stop.

51. Direct current recepticle can be a recepticle for conventional direct current plugs. It is expected that the sports bottle battery and other such batteries can be designed with built-in (voltage) meters. It is expeceted that the sports bottle battery can also be used to power other electronic/electric devices for bicycles.

52. Plate can be a part of the handlebar holder. It can be a flattened portion containing teeth that is designed fit into a toothed slot on the frame with precision.

53. Wheel can be a wheel mounted to the reflector bracket. It can also be a bracket onto which the reversable reflector light can be mounted. Once mounted, the reversable reflector light can be turned one hundred and eighty degrees to switch from a conventional bicycle front reflector (that can alo serve as a running or headlight) to a headlight and vice-versa. The wheel can be mounted with a torque setting that enables the wheel to retain its position yet is possible to turn without tools.

54. Second bicycle seat can be a bicycle seat with a built-in (tail) light/reflector. Seats with both pouches and tail lights are predicted.

55. Headlight switch can be a (glow-in-the-dark) push-button switch. It can be part of a circuit (not shown) that powers the second bulb. Such circuits are common in flashlights. Glow-in-the-dark switches for flashlights and the like are predicted. The headlight switch can be a switch for the headlight side of the reversable reflector light.

56. Reflector light switch can be a push-button (glow-in-the-dark) switch (of a different color and/or shape). It can be part of a circuit (not shown) that powers the bulb. Such circuits are common in flashlights. It can be a switch for the reflector light side of the reversable refector light.

57. Third bulb can be a light bulb. It is installed in a hole in the third reflector 62. The fit between the third bulb and the hole can be snug enough so that the third bulb retains positioning after installation. The third bulb is installed by pushing it into the hole.

58. Phone battery recepticle can be a phone battery recepticle. Such recepticles are common in cordless phones.

59. Bulb socket can be a piece of metal. It can be of a size that creates a snug fit with and subsequently an eletrical connection with the third bulb.

60. Switch can be a rocker switch. It is glued onto the outside of the light. The leads are fed through to holes of fitting sizes in the light. It can energize or de-energize the bulb. It is expected that the light can be designed with a central location for the switch to retain a symetrical look without the use of the second switch.

61. Phone battery can be a conventional cordless phone battery.

Related to the use of a phone battery as a power source for a bicycle light is another predicted concept; the use of phone batteries as a power source for all battery operated devices. Such devices would be designed to use phone batteries instead of conventional cylindrical batteries, propriatary rechargable batteries or other batteries. This gives devices with rechargable batteries a free charing system; the phone can be used as a charger. Also related is another predicted concept; adaptors for phone battery connectors. The adaptors would adapt between the different types of phone battery connectors to make them compatible with the recpeticles of the proposed devices. The concept is previously explained in “phone battery devices” Ser. No. 10/096,975. It is expected that the devices would be designed so that the phone batteries are easily replaceable.

Also related to the use of the phone battery as a power source for bicycle lights is another predicted concept; a (hand held) vacume cleaner with (conventional wall mount) charger (in the case of hand held vacume cleaners), that is designed to use rechargable batteries that are easily replacable and available at retail stores. It is expected that other devices can be designed to use the predicted vacume batteries as a power source. It is expected that such devices would be designed so that the vacume batteries are easily replacable.

62. Third reflector can be a (colored) mirror finish piece of plastic. It is glued into the light.

63. First wire can be a ridgid wire. One end of it is connected to the first recepticle lead 71, the other end of it is connected to one of the leads of the first switch.

64. Second switch can be a rocker switch. It is glued to the outside of the light and the leads are pushed through (fitting) holes in the light. It is there to retain a symetrical look for the light. It is expected that the light can be designed with a second light bulb (placed in another hole in the third reflector) that is wired to the second switch.

65. Latch can be a latch such as that which is commonly found on doors for battery compartments on remote controls.

66. Phone battery connector can be the connector of the cordless phone battery.

67. Third wire can be a wire. One end of it is connected to the other switch lead of the first switch, the other end of it is connected to the bulb socket.

68. Battery compartment can be a compartment that the cordless phone battery fits into.

69. Cover can be a cover for the battery compartment. Such covers are common on remote controls.

70. Phone battery wires can be the wires of a cordless phone battery that connect the connector to the batteries.

71. First recepticle lead can be a ridged wire.

72. Second recepticle lead can be a ridged wire. The recepticle leads are glued into fitting holes in the recepticle.

73. Bicycle sticker can be a sticker or (removable) decal that is designed for bicycles. Related to the bicycle sticker is another concept; green representations (such as the one illustrated in FIG. 17) of marine mammals. Also related to the bicycle sticker is another related concept; a (lighted) sign (containing one or more humerous illustrations and/or pictures) (for bars and related estabolishments) that says “(please) don't squeeze the barman” or “(please) don't squeeze the bar man”.

74. Green dolfin is a (green) representation of a dolfin. Such repesentations (green) of other marine mammals are also predicted for stickers and the like. Also predicted is the addition of words (such as “greenpeace”) (optionally) to such stickers. It is expected that the concept can be applied to other forms of art.

75. Frame can be a (tubular) part of a bicycle frame. The rest of the bicycle is not shown.

76. Second wire can be a ridged wire. One end of it is connected to the second recepticle lead, the other end of it is situated so that contact is made between it and the bottom of the third bulb when it is installed.

1. The modification described here-in for bicycle lights that encompasses a retractable telescoping rear-view mirror.

2. The use of telescoping modification described here-in for retractable handlebar devices as described in handlebar devices (Ser. No. 09/451,020).

3. The modificion for bicycle lights described here-in as a built-in (glow-in-the-dark) compass.

4. The grip as described here-in for hand brake levers.

5. The modification for bicycle frames described here-in encompassing a mechanism that enables adjustability of handlebar positioning.

6. The modification for bicycle seats described here-in encompassing a built-in pouch.

7. The modification for bicycle seats described here-in encompassing a built-in tail light.

8. The modification for the bicycle front reflector described here-in as a reversable reflector light.

9. The battery for the bicycle water bottle holder as described here-in.

10. The battery swapping method described here-in as a means for energy refills for bicycles with electric motors and other such vehicles.

11. The bicycle sticker concept as described here-in.

12. A bicycle light that is designed to use a cordless phone battery as a power source.

13. The use of cordless phone batteries as a power source for all battery powered devices.
